(19) United States
(12) Patent Application Publication
(10) Pub. No.: US 2025/0229243 A1
(43) Pub. Date: Jul. 17, 2025

(54) IMPROVEMENTS RELATING TO CATALYST CARRIERS FOR TUBULAR REACTORS AND ASSOCIATED METHODS

(71) Applicant: JOHNSON MATTHEY DAVY TECHNOLOGIES LIMITED, London (GB)

(72) Inventors: Jay Simon CLARKSON, Stockton-on-Tees (GB); Henry Arthur CLAXTON, London (GB); Andrew James COE, London (GB); Ben Geoffrey MALLAM, Stockton-on-Tees (GB)

(21) Appl. No.: 18/841,931

(22) PCT Filed: Mar. 16, 2023
(86) PCT No.: PCT/GB2023/050614

§ 371 Date: Aug. 27, 2024

(30) Foreign Application Priority Data
Mar. 17, 2022 (GB) 2203700.6

(51) Int. Cl. B01J 8/06; B01J 8/02; B01J 19/00; B01J 19/24

(52) U.S. Cl. CPC B01J 8/06; B01J 8/025; B01J 19/0073; B01J 19/2425; B01J 19/2485; B01J 2208/06; B01J 2219/2443

(57) ABSTRACT

A method of operating a tubular reactor, the method comprising, for at least some of the reactor tubes, the steps of: a) connecting together two or more catalyst carriers to form a linked set; b) installing into the reactor tube the linked set and an additional plurality of catalyst carriers that are unconnected to the linked set so that the linked set and the additional plurality of catalyst carriers extend at least partway between an inlet end of the reactor tube and an outlet end of the reactor tube, with the linked set being proximate the inlet end; c) operating the tubular reactor to pass one or more reactants through the reactor tube from the inlet end to the outlet end; and d) subsequently, withdrawing the linked set from the inlet end of the reactor tube while retaining the additional plurality of catalyst carriers within the reactor tube.

The present disclosure relates a method of operating a tubular reactor and a linked set of catalyst carriers for use in a tubular reactor.

### BACKGROUND

Conventional, so-called fixed-bed tubular, reactors comprise a reactor shell containing a plurality of tubes, which are usually cylindrical, and which are usually directly filled with catalyst particles. In use, a heat-transfer medium flows through the shell of the reactor outside these tubes and thereby adjusts the temperature of the catalyst in the tubes by heat exchange across the tube wall. Thus, where the reaction is an exothermic reaction, the heat-transfer medium will allow heat to be removed from the catalyst and where the reaction is an endothermic reaction, the heat-transfer medium will provide heat to the catalyst.

For some reactions, the heat effects of the reaction are moderate such that they are either not problematic or they can be readily managed. In some cases, the heat effects are sufficiently small that large-diameter tubes may be used. This has the benefit that there is a large volume of catalyst within the tube.

However, for more exothermic or endothermic reactions it is necessary that there is efficient heat transfer via the tube wall to the heat transfer medium to enable the conditions within the reactor to be controlled, in order to maintain a stable operating temperature to avoid detrimental effects occurring. Such effects, for exothermic reactions, may include side reactions taking place, damage to the catalyst such as by sintering of the catalytic active sites, and, in a worst case, thermal runaway. Detrimental effects for endothermic reactions may include quenching of the reaction.

To achieve the desired efficiency, the surface area of the tube wall per unit length has to be maximised. This has in the past been achieved by installing a greater number of smaller-diameter tubes. In some reactions, the size restriction means that the tubes are only of the order of about 15 to 40 mm internal diameter. However, the use of this multiplicity of tubes increases the cost and complexity of the reactor.

Thus, in an attempt to mitigate these problems, an alternative approach has been developed, in particular for more exothermic or endothermic reactions, in which the catalyst is not directly packed into the reactor tubes but is instead contained in a plurality of catalyst carriers that are configured to sit within the reactor tube.

WO2011/048361, WO2012/136971 and WO2016/050520 describe some examples of catalyst carriers configured for use in tubular reactors.

Catalyst carriers may usefully be used for a wide range of processes. Examples of suitable uses include processes and reactors for exothermic reactions such as reactions for the production of methanol, reactions for the production of ammonia, methanation reactions, shift reactions, oxidation reactions such as the formation of maleic anhydride and ethylene oxide reactions and the like. A particular example where catalyst carriers may be used is in processes and reactors for performing the Fischer-Tropsch reaction. Catalyst carriers may also be used for endothermic reactions such as pre-reforming, dehydrogenation and the like.

During operation of a tubular reactor, one or more reactants are flowed through the reactor tubes so as to pass into and through the catalyst carriers and thereby contact the catalyst contained therein. The catalyst(s) and reactant(s) chosen will be dependent on the desired process taking place in the tubular reactor, and these can vary widely. In one example, a tubular reactor may be configured for a Fischer-Tropsch process. In this example the catalyst will be a Fischer-Tropsch catalyst, for example a transition metal catalyst, for example a cobalt-containing Fischer-Tropsch catalyst. The reactant(s) for the Fischer-Tropsch process may comprise hydrogen and carbon monoxide gases which may be derived from syngas.

The catalysts used in catalyst carriers may ‘poisoned’ if exposed to substances that damage the catalyst. In the example of the Fischer-Tropsch catalyst, when syngas is formed it may contain poisons, such as sulphur, which can permanently damage the catalyst. Typically, the syngas will be subjected to a purification pre-treatment to remove the sulphur before it reaches the tubular reactor. However, there remains a risk that the purification pre-treatment may not fully remove all of the poisonous substances in the syngas, for example due to the use of out-of-specification syngas or a malfunction in the purification pre-treatment.

Poisoning of the catalyst in the catalyst carriers, typically first affects the carriers closer to the inlets of the tubes and can necessitate the replacement of those catalyst carriers. This requires the tubular reactor to be taken offline. A tubular reactor may comprise a large number of reactor tubes, for example up to 5000 reactor tubes may be present. In addition, each reactor tube may contain a large number of catalyst carriers. The reactor tubes may share a common headspace for supplying the reactants to the reactor tubes. Therefore, an acute poisoning event, or a more-gradual poisoning over time, may affect a large number, and potential all of the reactor tubes of the tubular reactor. Even if the poisoning only affects catalyst carriers nearer the inlet of the tubes, when it effects catalyst carriers in many or all of the tubes this can result in a very significant period of downtime of the tubular reactor while those catalyst carriers are being replaced, leading to significant economic loss.

### SUMMARY OF THE DISCLOSURE

In a first aspect of the present disclosure there is provided a method of operating a tubular reactor, the tubular reactor comprising a plurality of reactor tubes configured to receive catalyst carriers configured to hold catalyst, the method comprising, for at least some of the reactor tubes, the steps of:
a) connecting together two or more catalyst carriers to form a linked set;
b) installing into the reactor tube the linked set and an additional plurality of catalyst carriers that are unconnected to the linked set so that the linked set and the additional plurality of catalyst carriers extend at least part way between an inlet end of the reactor tube and an outlet end of the reactor tube, with the linked set being proximate the inlet end;
c) operating the tubular reactor to pass one or more reactants through the reactor tube from the inlet end to the outlet end; and
d) subsequently, withdrawing the linked set from the inlet end of the reactor tube while retaining the additional plurality of catalyst carriers within the reactor tube.

Beneficially, the method may permit the catalyst carriers that were positioned most proximate the inlet end of the reactor tube during operation to be withdrawn quickly and efficiently. This may significantly reduce the downtime of the tubular reactor since the time-saving generated for a single reactor tube may be multiplied many times when it is considered that catalyst carriers may need to be withdrawn from all of the reactor tubes, that may number in the hundreds or thousands in a single tubular reactor. It will be appreciated that, because a poisoning event effects the catalyst carriers proximate the inlet end most severely, the additional plurality of catalyst carriers may be unaffected, or less affected, by the poisoning event and therefore withdrawing and replacing only the linked set may result in significant remediation of the poisoning event while minimising downtime.

Preferably, the linked set is withdrawn in one go while retaining the two or more catalyst carriers of the linked set connected to one other. This may increase the efficiency of the process by enabling the linked set of catalyst carriers to be withdrawn in a single operation.

The method may further comprise the step of:
c1) determining that a poisoning event has occurred that has affected catalyst held in the linked set and, based on that determination, proceeding with step d).

A particular benefit of the method is for efficiently removing catalyst carriers from the reactor tube that have been subjected to poisoning. Thus, it may be particularly beneficial to perform step d) only once it has been determined that a poisoning event has occurred. That may be determined, for example, by observing a loss of production coinciding with a temperature profile change in the catalyst carriers proximate the inlet end of the reactor tube, and/or by observing reduced heat being exchanged into a heat transfer fluid on a shell side of the reactor. For example, where the shell side comprises boiling water, reduced steam production may be observed following a poisoning event, which may coincide the lost production and/or a change in temperature profile in the catalyst carriers. The poisoning event may be an acute event that lasts a relatively short period of time, for example a malfunction of the syngas purification pre-treatment apparatus that results in a high concentration of a poison such as sulphur reaching the tubular reactor. Alternatively, the poisoning event may be a more extended, gradual event that takes place over an extended period of time, for example degradation of the catalyst from long-term exposure to very small concentrations of one or more poisons.

The method may further comprise the step of:
e) installing into the reactor tube a fresh linked set of two or more catalyst carriers to replace the withdrawn linked set.

Beneficially, the tubular reactor may be readied for continued operation by replacing the catalyst carriers. A fresh linked set of catalyst carriers may be used in case a second subsequent poisoning event occurs.

Preferably, the linked set is installed into and withdrawn from the inlet end of the reactor tube. Advantageously, the additional plurality of catalyst carriers in the reactor tube do not need to be moved or disturbed during the withdrawal and replacement of the linked set.

Preferably in step b) the additional plurality of catalyst carriers are installed first followed by the linked set.

The two or more catalyst carriers of the linked set may be connected together by permanent or releasable means. In some examples the catalyst carriers may be welded together. In other more preferred examples, the connection means may comprise a push fit, for example an interference fit between adjacent catalyst carriers. Alternatively, and most preferably, in some examples the connection means may comprise relative rotational coupling of adjacent catalyst carriers. Such means may be better adapted for retaining the connection when the linked set is subjected to an axial, pulling thrust. For example, a bayonet fitting may be provided. Alternatively a screw-threaded connection may be provided.

The linked set may consist of only catalyst carriers that each contain a catalyst. However, in alternative examples, the linked set may additionally comprise one or more elements that do not contain catalyst. In some examples, the linked set may comprise a spacer unit connected to the two or more catalyst carriers, the spacer unit being provided at one end of the linked set. Beneficially, on installing the linked set into the reactor tube the spacer unit may be aligned with a first or top sheet of the tubular reactor. The spacer unit may function to help ensure that all of the catalyst contained in the linked set is positioned below the first or top sheet of the tubular reactor so that it is within a heat-exchange zone of the tubular reactor.

Preferably, the spacer unit and the two of more catalyst carriers of the linked set are connected together. The means of connection may be the same as described above, for example, a bayonet fitting, an interference fit, etc.

In some embodiments the linked set of catalyst carriers may comprise a different catalyst to the additional plurality of catalyst carriers. For example, the linked set may comprise a catalyst designed to efficiently remove poisons. Such a poison removal catalyst may for example be a sulphur removal catalyst. The linked set may thus function as a replaceable guard section at the inlet of each reactor tube.

The linked set may for example comprise from 2 to 20, and preferably from 5 to 15, catalyst carriers optionally together with a spacer unit. A linked set of that size may be sufficiently long to include all catalyst carriers that are likely to be significantly affected by a poisoning event, while still being of a size that is practical to withdraw efficiently with a significant time saving compared to replacement of all the catalyst carriers in the tube.

The method may further comprise providing an inlet end of the linked set with an attachment point, and withdrawing the linked set from the inlet end of the reactor tube may comprise attaching a tool to the attachment point and, for example, pulling the linked set out of the inlet end using the tool.

Beneficially, provision of the attachment point may simplify the withdrawal of the linked set.

The attachment point may, for example, comprise or consist of a hook, eyelet, catch, aperture or other means that can be engaged by the tool to permit the tool to apply a thrust to the linked set, e.g. a pulling force to urge the linked set towards the inlet end of the reactor tube.

The attachment point may be provided on a catalyst carrier or spacer unit of the linked set.

Preferably, the attachment point is provided on the carrier or unit most proximate the inlet end and may, for example, be provided on an end face of the carrier or unit facing the inlet end.

The tool may be driven manually, hydraulically, pneumatically, or electro-mechanically. The tool may be used to install and withdraw catalyst carriers into and from the reactor tube.

The tool may comprise a movable ram, for example a manually- or hydraulically-driven ram, configured for pushing and/or pulling carrier carriers into and/or out of the reactor tube.

In some examples, the tool may be an installation tool comprising:
a) an installation frame;
b) the movable ram mounted to the installation frame and configured for pushing and pulling one or more catalyst carriers into and out of a selected reactor tube; and
c) one or more anchors for engaging in one or more reactor tubes located alongside the selected reactor tube so as to releasably attach the installation frame to the tubular reactor.

Preferably, at least one of the catalyst carriers of the linked set is provided with a seal that engages against an inner surface of the reactor tube such that liquids and gases passing along the reactor tube are preferentially directed to flow through an interior of the catalyst carrier. Where a spacer unit is present the spacer may also comprise a seal, but this is not required since the spacer unit will typically not contain any catalyst.

Preferably, the seal may be configured to permit the catalyst carrier to be installed into the reactor tube in a first direction and withdrawn from the reactor tube in a second direction opposite to the first direction. For example, the seal may be configured to accommodate movement of the catalyst carrier in both the first and the second direction. The seal may, for example, be configured to form a sliding seal against the inner surface of the reactor tube. The sliding seal may be enabled to slide in both directions.

In some examples, the seal may comprise an O-ring, ceramic fibre ring, or metal brush seal. In particular, these seals may be deformed on installing the catalyst carrier into the reactor tube. The amount of deformation may be configured to achieve a required seal integrity while also permitting sliding movement in the first and the second direction.

In some other examples the seal may have a geometry that can be deformed from a first configuration enabling sliding movement in the first direction, into a second configuration enabling sliding movement in the second direction. For example, the seal may be deformed into a first configuration on installing the catalyst carrier into the reactor tube and when withdrawn the seal may be deformed into its second configuration. For example, the seal may comprise one or more layers that extend outwardly from a container of the catalyst carrier.

The seal may comprise at least a first seal layer and a second seal layer; the first seal layer and the second seal layer each comprising a plurality of deflectable tongues separated by notches; the second seal layer being rotationally offset about the longitudinal axis of the catalyst carrier relative to the first seal layer such that the notches of the second seal layer are aligned with the deflectable tongues of the first seal layer.

The seal may be deformed on installation into a first configuration wherein the one or more layers are flexed to point back towards the inlet end of the reactor tube. The seal may be deformed on withdrawal into a second configuration wherein the one or more layers are flexed to point back towards the outlet end of the reactor tube during withdrawal. The seal may be chosen to be relatively flexible to permit the seal to adopt both the first configuration and the second configuration.

In a second aspect of the present disclosure there is provided a linked set of two or more catalyst carriers, wherein the two or more catalyst carriers are connected together end-to-end, the linked set comprising an attachment point for withdrawing the linked set in one go from an inlet end of a reactor tube.

The linked set may additionally comprise a spacer unit connected to the two or more catalyst carriers, the spacer unit being provided at one end of the linked set and comprising the attachment point.

At least one of the catalyst carriers of the linked set may be provided with a seal for engaging an inner surface of a reactor tube. The seal may be as described above with respect to the first aspect.

For example, the seal may be configured to permit the catalyst carrier to be installed into the reactor tube in a first direction and withdrawn from the reactor tube in a second direction opposite to the first direction. For example, the seal may be deformable. For example, the seal may comprise one or more layers that extend outwardly from a container of the catalyst carrier. For example, the seal may comprise at least a first seal layer and a second seal layer; the first seal layer and the second seal layer each comprising a plurality of deflectable tongues separated by notches; the second seal layer being rotationally offset about the longitudinal axis of the catalyst carrier relative to the first seal layer such that the notches of the second seal layer are aligned with the deflectable tongues of the first seal layer. For example, the seal may be deformable on installation such that the one or more layers are flexed to point back towards the inlet end of the reactor tube during installation. For example, the seal may be deformable on withdrawal such that the one or more layers are flexed to point back towards the outlet end of the reactor tube during withdrawal. For example, the seal may comprise an O-ring, ceramic fibre ring, or metal brush seal.

The present methods and linked sets may usefully be used for a wide range of processes. Examples of suitable uses include processes and reactors for exothermic reactions such as reactions for the production of methanol, reactions for the production of ammonia, methanation reactions, shift reactions, oxidation reactions such as the formation of maleic anhydride and ethylene oxide reactions and the like. A particularly preferred use is in processes and reactors for performing the Fischer-Tropsch reaction.

Endothermic reactions such as pre-reforming, dehydrogenation and the like may also be carried out in conjunction with the present methods and linked sets.

The catalyst carriers of the present disclosure may be filled or partially filled with any catalyst suitable for the intended reaction. For example, a Fischer-Tropsch catalyst may be used for the Fischer-Tropsch reaction. Cobalt-containing Fischer-Tropsch catalysts are preferred. The catalyst may be provided as catalyst particles or a catalyst monolith. The catalyst may be provided as a single bed of catalyst or multiple beds of catalyst. The catalyst carrier may be configured to promote axial and/or radial flow through the catalyst.

In some embodiments the catalyst carrier may be configured to preferentially promote radial flow through the catalyst.

The catalyst carriers of the present disclosure may be formed of any suitable material. Such material will generally be selected to withstand the operating conditions of the tubular reactor. The catalyst carrier may be fabricated from carbon steel, aluminium, stainless steel, other alloys or any material able to withstand the reaction conditions.

### BRIEF DESCRIPTION OF THE DRAWINGS

Embodiments of the present disclosure will now be described, by way of example only, with reference to the accompanying drawings, in which:

FIG. 1 is a schematic side view of a tubular reactor;

FIG. 2 is a schematic cross-sectional view of a portion of the tubular reactor of FIG. 1;

FIG. 3 is a perspective view of a catalyst carrier;

FIG. 4 is a cross-sectional view of the catalyst carrier of FIG. 3;

FIG. 5 is an exploded perspective view of the catalyst carrier of FIG. 3;

FIG. 6 is a plan view of a seal layer for a catalyst carrier;

FIG. 7 is a schematic side view showing an arrangement of a plurality of seal layers;

FIG. 8 is a plan view of first and second seal layers for a catalyst carrier;

FIG. 9 is a perspective view of another catalyst carrier;

FIG. 10 is a side view of two of the catalyst carriers of FIG. 9 connected together;

FIG. 11 is a cross-sectional view of the catalyst carriers of FIG. 10; and

FIG. 12 is a schematic view of an upper portion of the tubular reactor of FIG. 1.

### DETAILED DESCRIPTION

In the following, aspects and embodiments of the present disclosure will be described, by way of example only, with reference to a vertically orientated tubular reactor having a plurality of vertical reactor tubes extending between an upper tube sheet and a lower tube sheet. However, it will be understood that the present disclosure may also be applied to other configurations of tubular reactor that may adopt other orientations.

Additionally, in this specification any reference to orientation; for example, terms such as top, bottom, upper, lower, above, below and the like is used with regard to the orientation of the parts as illustrated in the drawings being referenced but is not to be seen as restrictive on the potential orientation of such parts in actual use. For example, a part described as being orientated vertically may also be orientated horizontally.

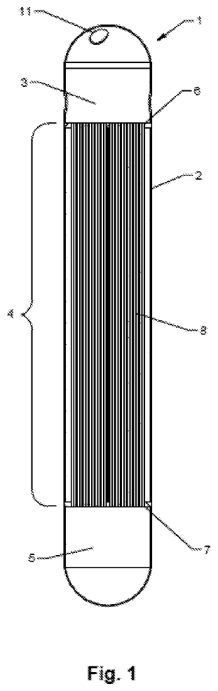

FIG. 1 shows a typical layout of a tubular reactor 1 of the present disclosure. The tubular reactor 1 comprises a housing 2. The interior of the housing may be divided into a head space 3, a heat-exchange zone 4 and a footer space 5 by two tube sheets—an upper tube sheet 6 and a lower tube sheet 7. The upper tube sheet 6 separates the head space 3 from the heat-exchange zone 4. The lower tube sheet 7 separate the footer space 5 from the heat-exchange zone 4.

A plurality of reactor tubes 8 extend between the upper tube sheet 6 and the lower tube sheet 7. A large number of reactor tubes 8 may be provided, for example between 20 and 5000 reactor tubes 8 may be present. Each reactor tube 8 may have, for example, an internal diameter of between 20 and 150 mm. In some embodiments the internal diameter may be about 85 mm.

Each reactor tube 8 is intended to be filled or substantially filled with a stacked arrangement of catalyst carriers 10. In particular, it is typically desired that the catalyst carriers 10 cover all or substantially all of the length of the reactor tube 8 between the upper tube sheet 6 and the lower tube sheet 7, i.e. that they cover all or substantially all of the length of the heat-exchange zone 4.

The head space 3 may provide access to an upper end of the reactor tubes 8 to allow loading of the catalyst carriers 10 into the reactor tubes 8. An access opening 11 may be provided in the housing 2 to allow access to the head space 3. The access opening 11 may, for example, be a manhole or other access panel that can be selectively opened and closed.

The footer space 5 may provide access to the lower end of the reactor tubes 8 to allow unloading of the catalyst carriers 10 from the reactor tubes 8. For example, access to the footer space 5 may be provided by an access opening (not shown) similar to the access opening 11 into the head space 3.

According to the present disclosure a method of operating the tubular reactor 1 is provided.

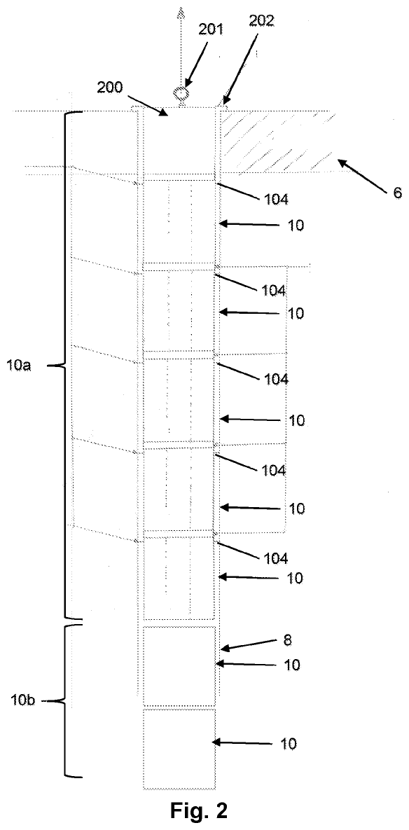

In general, the method comprises, for at least some of the reactor tubes 8, the steps of:
a) connecting together two or more catalyst carriers 10 to form a linked set 10a;
b) installing into the reactor tube 8 the linked set 10a and an additional plurality of catalyst carriers 10b that are unconnected to the linked set 10a so that the linked set 10a and the additional plurality of catalyst carriers 10b extend at least part way between an inlet end (for example the upper end) of the reactor tube 8 and an outlet end (for example the lower end) of the reactor tube 8, with the linked set 10a being proximate the inlet end as illustrated in FIG. 2;
c) operating the tubular reactor 1 to pass one or more reactants through the reactor tube 8 from the inlet end to the outlet end; and
d) subsequently, withdrawing the linked set 10a from the inlet end of the reactor tube 8 while retaining the additional plurality of catalyst carriers 10b within the reactor tube 8.

It will be understood that, while FIG. 2 shows a total of 7 catalyst carriers 10, a reactor tube 8 in a commercial reactor is likely to contain 50 or more catalyst carriers 10. Typically, around 2 to 20, preferably 5 to 15, or the catalyst carriers 10 would be in linked set 10a and the remainder would be the additional plurality of catalyst carriers 10b.

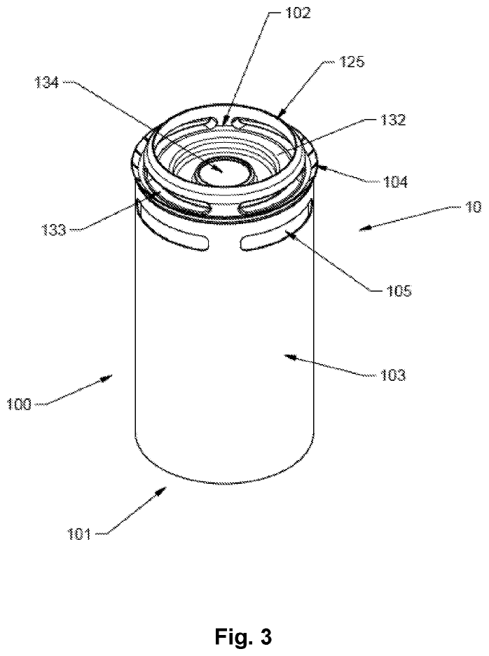

To better understand the present disclosure, examples of the general configuration of a catalyst carrier 10 will first be described with reference initially to FIGS. 3 to 5. This general configuration may be used for both the catalyst carriers 10 of the linked set 10a and the additional plurality of catalyst carriers 10b. (The differences between them will be described below.) However, it will be understood that the catalyst carriers 10 may take various forms. For example, as well as the examples described herein, the catalyst carriers 10 may take other general configurations including but not limited to those disclosed in WO2011/048361, WO2012/136971 and WO2016/050520, the contents of which are herein incorporated by reference in their entirety.

Each catalyst carrier 10 may generally comprise a container that is sized such that it is of a smaller dimension than the internal dimension of the reactor tube 8 into which it is to be placed in use. Typically, a seal will be provided that is sized such that it interacts with the inner wall of the reactor tube 8 when the catalyst carrier 10 is in position within the reactor tube 8. Parameters such as carrier length and diameter may be selected to accommodate different reactions and configurations of reactor tube 8.

As shown in FIGS. 3 to 5, the container 100 may generally have a bottom surface 101 that closes a lower end of the container 100 and a top surface 102 at an upper end of the container 100. A carrier outer wall 103 may extend from the bottom surface 101 to the top surface 102. A seal 104 (described further below) may extend from the container 100 by a distance which extends beyond the carrier outer wall 103. The carrier outer wall 103 may have apertures 105 located below the seal 104.

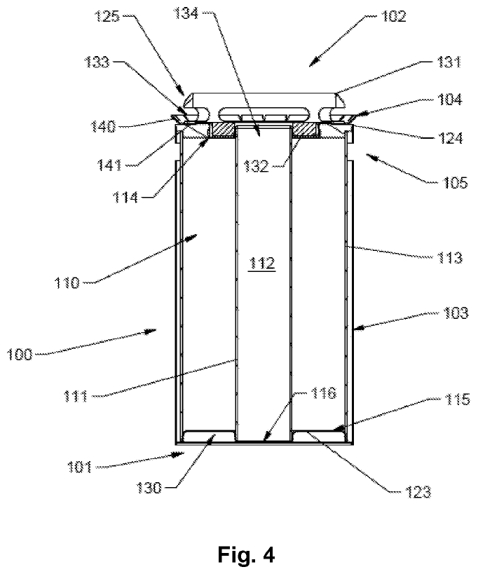

As shown in FIG. 4, the catalyst carrier 10 may more particularly comprise an annular container 110 for holding catalyst in use. The annular container 110 may comprise a perforated inner container wall 111 that defines an inner channel 112 and a perforated outer container wall 113 that may be concentrically arranged about the perforated inner container wall 111. An annular top surface 114 may close an upper end of the annular container 110 and an annular bottom surface 115 may close a lower end of the annular container 110. A lower end of the inner channel 112 may be closed off by a channel end surface 116 except for one or more drain apertures (not shown) that may be provided in the lower end of the inner channel 112. The channel end surface 116 may be formed integrally or separately to the inner container wall 111.

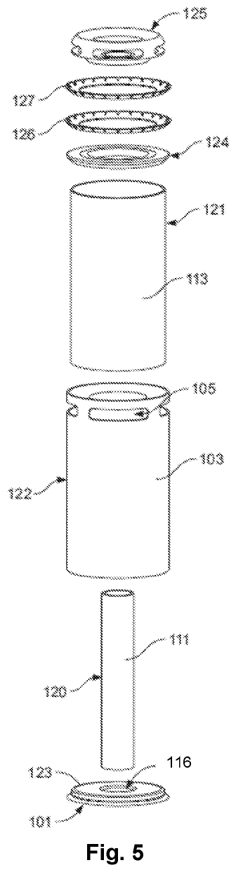

As shown in the exploded view of FIG. 5, the catalyst carrier 10 may be formed from a number of individual components that may be assembled together by any suitable means, including for example welding. In some embodiments such components may include a perforated inner tube 120, a perforated intermediate tube 121, an outer tube 122, a bottom cap 123, an annular top ring 124, a top cap 125 and annular seal rings 126 and 127.

The catalyst carrier 10 may be formed of any suitable material. Such material will generally be selected to withstand the operating conditions of the reactor. Generally, the catalyst carrier will be fabricated from carbon steel, aluminium, stainless steel, other alloys or any material able to withstand the reaction conditions.

Suitable thicknesses for the components will be of the order of about 0.05 mm to about 1.0 mm, preferably of the order of 0.1 mm to about 1.0 mm, more preferably of the order of about 0.3 mm to about 1.0 mm.

The perforated inner tube 120 may comprise the perforated inner container wall 111. The perforated intermediate tube 121 may comprise the perforated outer container wall 113. The outer tube 122 may comprise the carrier outer wall 103 and define the apertures 105. The bottom cap 123 may comprise the bottom surface 101 and/or the annular bottom surface 115. The bottom cap 123 may also extend across the perforated inner tube 120 to comprise the channel end surface 116. The annular top ring 124 and the top cap 125 may comprise the annular top surface 114 and may comprise at least part of the top surface 102. The annular seal rings 126 and 127 may comprise the seal 104.

The size of the perforations in the perforated inner tube 120 and the perforated intermediate tube 121 will be selected such as to allow uniform flow of reactant(s) and product(s) through the catalyst while maintaining the catalyst within the annular container 110. It will therefore be understood that their size will depend on the size of the catalyst particles being used. In an alternative arrangement the perforations may be sized such that they are larger but have a filter mesh covering the perforations to ensure catalyst is maintained within the annular container 110.

It will be understood that the perforations may be of any suitable configuration. Indeed, where a wall or tube is described as perforated, all that is required is that there is means to allow the reactants and products to pass through the walls or tubes.

The bottom surface 101, for example the bottom cap 123, may be shaped to engage with an upper end of another catalyst carrier 10. For example, the bottom surface 101 may comprise an annular recess 130 around the perforated inner tube 120. The top cap 125 may be shaped to engage in the annular recess 130 of another catalyst carrier 10. For example, the top cap 125 may comprise an annular ring 131 that upstands from an annular plug body 132. The annular ring 131 may be shaped and sized to be received in the annular recess 130.

The bottom surface 101, for example the bottom cap 123 and/or channel end surface 116 may include one or more drain holes. Where one or more drain holes are present, they may be covered by a filter mesh.

The annular top ring 124 may be shaped and sized to engage in an upper end of the outer tube 122. The annular plug body 132 of the top cap 125 may have an outer diameter configured to engage with a central aperture of the annular top ring 124. Engagement of the top cap 125 with the annular top ring 124 may function to sandwich and retain the annular seal rings 126 and 127 in position.

The top cap 125 may comprise a central inlet 134 in the annular plug body 132 for enabling entry of liquids and gases into the upper end of the inner channel 112. The annular ring 131 may comprise lateral apertures 133 than enable liquids and gases to reach the central inlet 134.

The carrier outer wall 103 may be smooth or it may be shaped. Suitable shapes include pleats, corrugations, and the like.

The apertures 105 in the carrier outer wall 103 may be of any configuration. In some embodiments, the apertures 105 may be holes or slots.

The carrier outer wall 103 may continue above the seal 104. Thus, the seal 104 may be located at the top of the catalyst carrier 10, optionally as part of the top surface 102, or it may be located at a suitable point on the carrier outer wall 103 provided that it is located above the apertures 105 in the carrier outer wall 103.

The seal 104 may be sufficiently compressible to accommodate the smallest diameter of the reactor tube 8. The seal 104 may generally be a flexible, sliding seal. The seal 104 may engage against an inner surface of the reactor tube 8 such that liquids and gases passing along the reactor tube 8 are preferentially directed to flow through an interior of the catalyst carrier 10. The seal 104 may, for example, be configured to form a sliding seal against the inner surface of the reactor tube 8.

In the illustrated example of FIGS. 3 to 5, the seal 104 may comprise a deformable flange 140 extending from the carrier outer wall 103 or the top surface 102 of the catalyst carrier 10. The flange 140 may be sized to be larger than the internal diameter of the reactor tube 8 such that as the catalyst carrier 10 is inserted into the reactor tube 8 it is deformed to fit inside and interact with the reactor tube 8. The deformable flange 140 comprises an outer portion of the annular seal rings 126 and 127. An inner portion 141 of the annular seal rings 126 and 127 may define clamping surfaces that are sandwiched and retained between the top cap 125 and the annular top ring 124. The deformable flange 140 may be angled relative to the inner portion 141. The deformable flange 140 may be angled towards the upper end of the catalyst carrier 10.

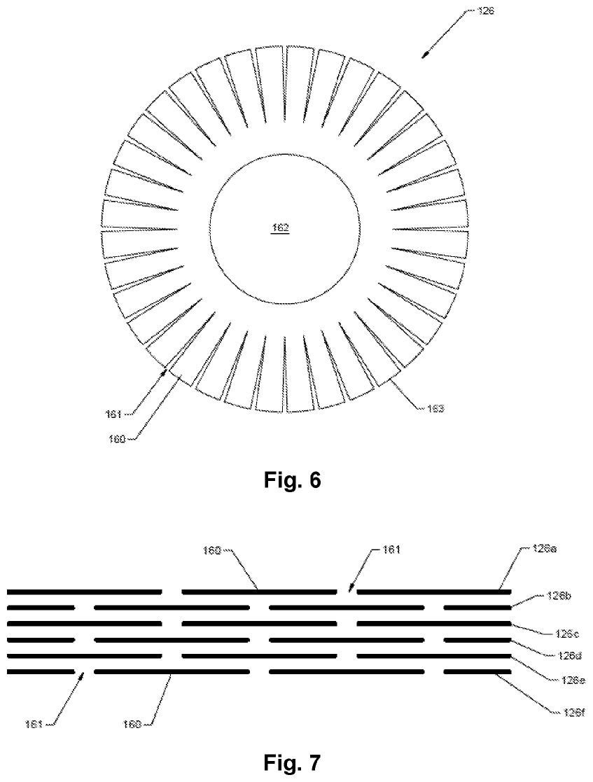

Whilst described above in relation to two annular seal rings 126 and 127, the seal 104 of this example may, for example, comprise a single layer of material. Thus, seal ring 127 may be absent and seal ring 126 may be configured, for example as a continuous annular ring to provide the seal 104. FIGS. 6 to 8 illustrate further details of an example of seal 104 which is comprised of at least a first seal layer 126 and a second seal layer 127. The seal 104 may comprise more than two seal layers 126, 127. For example, it may comprise four, five or six seal layers.

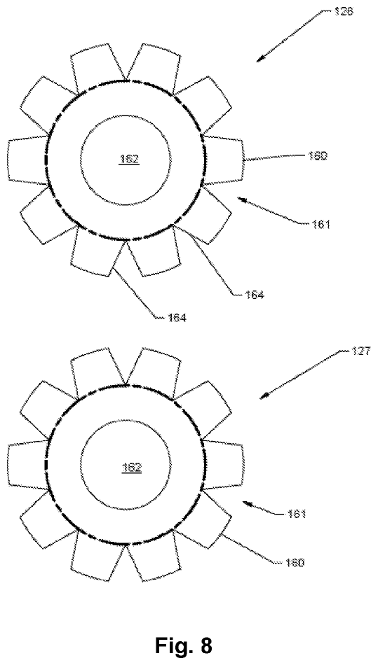

FIG. 6 illustrates an example of one seal layer 126. FIG. 7 illustrates how a plurality of seal layers 126a to 126f may be provided to form the seal 104. FIG. 8 illustrates another example of seal 104 formed from two seal layers 126, 127.

The seal layers 126, 127 may comprise portions of an integral sealing element, for example a helical element. Alternatively, and as illustrated in FIGS. 6 to 8, each seal layer 126, 127 may comprise a separate sealing element.

The first seal layer 126 and the second seal layer 127 overlie each other. Preferably, the layers 126, 127 are in face-to-face contact. Each seal layer 126, 127 may comprise a separate seal ring. Each seal layer 126, 127 may be flexible. Each seal layer 126, 127 may comprise an annular element. An outer edge of each annular element may generally be configured to match the shape of the inner surface of the reactor tube. The annular element may be circular. In some examples the outer diameter may be from 80 to 90 mm, optionally about 85 mm. The annular element may have a central aperture 162 for receiving the container of the catalyst carrier 10. The central aperture 162 may have a diameter from 55 to 65 mm, optionally about 60 mm. The outer diameter may be chosen to achieve a desired insertion force of the catalyst carrier 10 taking into account the inner diameter of the reactor tube in which the catalyst carrier 10 is to be installed.

Each seal layer 126, 127 may comprise a plurality of deflectable tongues 160 separated by notches 161. Thus, each of the first seal layer 126 and the second seal layer 127 (and any additional seal layers) may comprise a notched outer edge 163. Each seal layer 126, 127 may comprise from 5 to 80 deflectable tongues 160, optionally from 8 to 60 deflectable tongues 160, optionally about 40 deflectable tongues 160. Each pair of deflectable tongues 160 may be separated by one notch 161.

Each seal layer 126, 127 may be formed from a single piece of sheet material. The notched outer edge 163 may be formed by a suitable means such as cutting, stamping, etc. The material of each seal layer 126, 127 may be the same or may be different. Each seal layer 126, 127 may be formed from carbon steel, aluminium, stainless steel, other alloys or any material able to withstand the reaction conditions. The thickness of each seal layer 126, 127 may be the same or may be different. Different thicknesses may be used to configure different seal layers with different characteristics, including, for example, flexibility, stiffness, compressibility, etc. Each seal layer 126, 127 may have a thickness that is selected to achieve the required insertion force and flexibility of the deflectable tongues 160. In some examples the thickness of each seal layer 126, 127 may be from 15 micron to 500 microns (0.015 mm to 0.5 mm).

The notches 161 may vary in width from relatively narrow, as in the example of FIG. 6, to relatively wide, as in the example of FIG. 8. The notches 161 may comprise side walls 164 (as most clearly seen in FIG. 8) that are parallel or diverge towards an outer edge of the respective seal layer 126, 127. The notches 161 may be U-shaped or V-shaped.

The second seal layer 127 is preferably rotationally offset about the longitudinal axis of the catalyst carrier 10 relative to the first seal layer 126 such that the notches 161 of the second seal layer 127 are aligned with the deflectable tongues 160 of the first seal layer 126. Such a rotational offset advantageously minimises gas bypass.

The first seal layer 126 and the second seal layer 127 may extend perpendicularly from the container 100. Alternatively, the first seal layer 126 and the second seal layer 127 may be angled towards an upper end of the container 100, e.g. towards the top surface 102.

In some embodiments, the catalyst carrier 10 may comprise three or more seal layers 126, 127 each comprising a plurality of deflectable tongues 160 separated by notches 161. Each seal layer 126, 127 may be rotationally offset about the longitudinal axis of the catalyst carrier 10 relative to at least one of the other seal layers 126, 127 such that the notches 161 of each seal layer 126, 127 may be aligned with the deflectable tongues 160 of at least one of the other seal layers 126, 127. Preferably the notches 161 of each seal layer 126, 127 may be aligned with the deflectable tongues 160 of one or both adjacent seal layers 126, 127. For example, as illustrated in FIG. 7, the notches 161 of seal layer 126c are aligned with the deflectable tongues 160 of both seal layers 126b and 126d.

An inner edge of the seal layers 126, 127 may be attached together. The attachment may be created before or after the seal layers 126, 127 are attached to the container 100, for example by welding.

Each seal layer 126, 127 may comprise a key or keyway (not shown) for engaging a complementary keyway or key on the container 100 for maintaining relative rotational alignment of the seal layers 126, 127 with each other.

An inner portion of each seal layer 126, 127 may define a clamping surface that is sandwiched and retained between the top cap 125 and the annular top ring 124.

As noted above, according to the present disclosure some of the catalyst carriers 10 inserted into the reactor tube 8 are connected together to form the linked set 10a. The catalyst carriers 10 of the linked set 10a are, to this end, provided with means to enable them to be attached together. For example, adjacent catalyst carriers 10 of the linked set 10a may be connected together by engagement of the one or more co-operating formations.

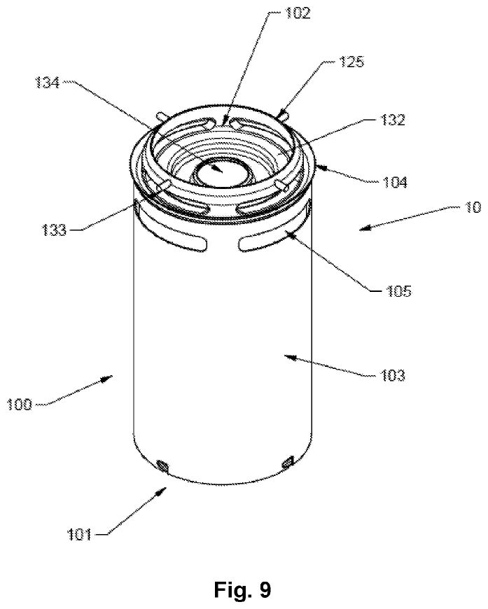

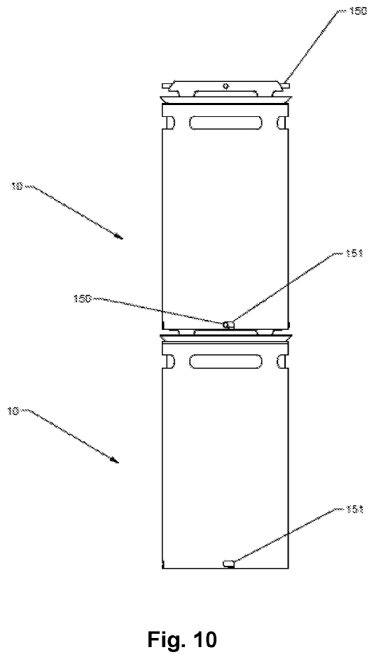

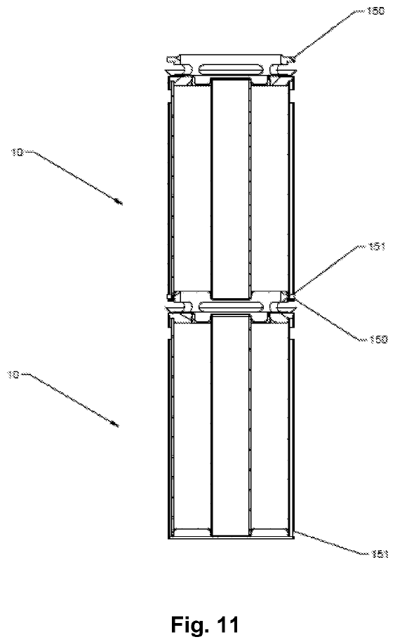

In some examples, each catalyst carrier 10 of the linked set 10a may comprise, as shown in FIGS. 9 to 11, upper co-operating formations 150 provided on or towards the upper end of the container 100 and lower co-operating formations 151 provided on or towards the lower end of the container 100. Adjacent catalyst carriers 10 may thereby be engaged together by engagement of the lower co-operating formations 151 on one catalyst carrier 10 with the upper co-operating formations 150 of an adjacent catalyst carrier 10 of the linked set 10a.

The upper co-operating formations 150 and the lower co-operating formations 151 may be configured to be engaged and disengaged by relative rotational movement of the adjacent catalyst carriers 10. For example, the upper co-operating formations 150 and the lower co-operating formations 151 may take the form of bayonet fittings as illustrated.

In some examples the upper co-operating formations 150 are provided above the seal 104. For example, the upper co-operating formations 150 may be provided on or as part of the annular ring 131 and/or an upper portion of the carrier outer wall 103.

The additional plurality of catalyst carriers 10b may be disconnected from each other. Alternatively, in some examples two or more of the catalyst carriers 10 of the additional plurality of catalyst carriers 10b may be engaged together to form an insertion set. However, the additional plurality of catalyst carriers 10b, whether separate or arranged in insertions sets, remain disconnected from the linked set 10a. Each insertion set of the additional plurality of catalyst carriers 10b may comprise, for example, two, three or more catalyst carriers 10 that are stacked one on top of the other. The catalyst carriers 10 may be permanently engaged together by a means such as welding. However, more preferably the catalyst carriers 10 are releasably engaged together. The releasable engagement may be, for example, by means of the same type of co-operating formations 150, 151 as discussed above.

The linked set 10a may consist of only catalyst carriers 10 that each contain a catalyst. However, in alternative examples, the linked set 10a may additionally comprise one or more units that do not contain catalyst. For example, as shown in FIG. 2, the linked set 10a may comprise a spacer unit 200 connected to the catalyst carriers 10 of the linked set 10a. The spacer unit 200 may be connected to one end of the linked set 10a. Preferably, on installing the linked set 10a into the reactor tube 8 the spacer unit 200 may be aligned with a upper tube sheet 6 of the tubular reactor 1. The spacer unit 200 may function to help ensure that all of the catalyst contained in the linked set 10a is positioned below the upper tube sheet 6 within the heat-exchange zone 4. The spacer unit 200 may also function to prevent upward creep of the catalyst carriers 10 during operation which might otherwise occur if a void space was left at the level of the upper tube sheet 6. The spacer unit 200 may comprise a projecting flange 202 as shown in FIG. 2 that may engage against the upper tube sheet 6 to provide a datum level for the insertion position of the spacer unit 200 and, thereby, the linked set 10a.

The means of connecting the spacer unit 200 and the adjacent catalyst carrier 10 of the linked set 10a may be the same as described above for the catalyst carriers 10 themselves, for example, a bayonet fitting, an interference fit, etc.

The spacer unit 200 may comprise an attachment point 201 to aid withdrawal of the linked set 10a from the upper, inlet end of the reactor tube 8. In FIG. 2, the attachment point 201 is exemplified as a ring.

At least one of the catalyst carriers 10 of the linked set 10a may be provided with a seal 104. In some examples, the seal 104 of the catalyst carriers 10 of the linked set 10a may differ in configuration from the seal 104 provided on the catalyst carriers 10 of the additional plurality of catalyst carriers 10b. For example, the seal 104 of the catalyst carriers 10 of the linked set 10a may be more flexible than the seal 104 provided on the catalyst carriers 10 of the additional plurality of catalyst carriers 10b. In other respects, the catalyst carriers 10 of the linked set 10a may have the same general configuration described above and illustrated in FIGS. 3 to 5.

Preferably, the seal or seals 104 of the linked set 10a is configured to permit the linked set 10a to be installed into the reactor tube 8 in a first direction and withdrawn from the reactor tube 8 in a second direction opposite to the first direction. For example, each seal 104 may be configured to form a sliding seal against the inner surface of the reactor tube 8. The sliding seal may be enabled to slide in both directions. In some examples, the seal 104 may comprise an O-ring, ceramic fibre ring, or metal brush seal.

In some examples, the seal 104 may be one of the types described above, e.g. a deformable flange 140, or a plurality of seal layers 126, 127 that work together as a seal. Where the seal 104 comprises a deformable flange 140 extending from the carrier outer wall 103 or the top surface 102 of the catalyst carrier 10, the material and/or thickness of the deformable flange 140 may be chosen so that the seal 104 is more flexible than the seal 104 of the catalyst carriers 10 of the additional plurality of catalyst carriers 10b. Where the seal 104 comprises a plurality of seal layers 126, 127, the material and/or thickness and/or number of the seal layers may be chosen so that the seal 104 is more flexible than the seal 104 of the catalyst carriers 10 of the additional plurality of catalyst carriers 10b. For example, the seal 104 being more flexible may enable it to adopt different configuration on installation into and withdrawal from the reactor tube 8. For example, the seal 104 may be deformed on installation into a first configuration wherein the flange 140 or layers 126, 127 are flexed to point back towards the inlet end of the reactor tube 8. The seal 104 may be deformed on withdrawal into a second configuration wherein the flange 140 or one or more layers 126, 127 are flexed to point back towards the outlet end of the reactor tube 8 during withdrawal.

Loading of the catalyst carriers 10 (both the linked set 10a and the additional plurality of catalyst carriers 10b) into the reactor tubes 8 may be carried out making use of a tool. The tool may be driven manually, hydraulically, pneumatically, or electro-mechanically. The tool may be used to install and withdraw catalyst carriers 10 into and from the reactor tube 8. The tool may comprise a movable ram, for example a manually- or hydraulically-driven ram, configured for pushing and/or pulling carrier carriers 10 into and/or out of the reactor tube 8.

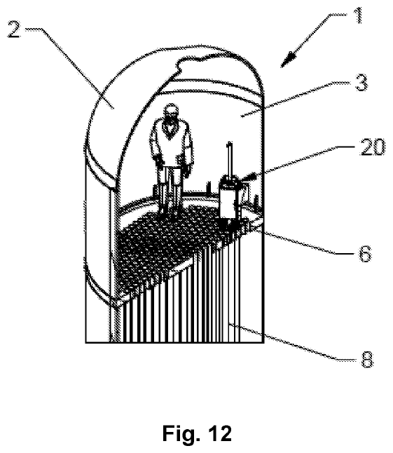

FIG. 12 illustrates an example of the tool configured as an installation tool 20 comprising an installation frame, an hydraulic ram mounted to the installation frame, and one or more anchors for anchoring the installation frame to the upper tube sheet 6 of the tubular reactor 1. The anchors function to releasably engage the installation frame, and hence the installation tool 20, to the tubular reactor 1. The installation tool may form part of an installation system that additionally comprises a source of motive power. The source of motive power may be located outside the tubular reactor 1 and configured to move the movable ram of the installation tool 20.

During insertion into the reactor tube 8, the seal 104 of the catalyst carrier 10 may sealingly engage with the inner surface of the reactor tube 8. In particular, engagement of the seal 104 against the reactor tube 8 may cause deformation of the seal 104. Deformation of the seal 104 may produce resistive forces that may help to maintain the axial position of the catalyst carriers 10 within the reactor tube 8 after installation. In addition, the deformation of the seal 104 may be used to promote a liquid-tight and/or gas-tight seal between the upper end of the catalyst carriers 10 and the inner surface of the reactor tube 8.

Once installed in the reactor tube 8, the catalyst carriers 10 may form a stacked arrangement, one on top of the other with their longitudinal axes aligned and coincident.

In use, catalyst carriers 10 are initially installed into the reactor tubes 8 of the tubular reactor 1 to preferably fill or substantially fill the tubular reactor 1. For at least some of the reactor tubes 8, and preferably for most if not all of the reactor tubes 8 that contain a stack of catalyst carriers 10, a linked set 10a of catalyst carriers 10 is installed after and above the additional plurality of catalyst carriers 10b so that the linked set 10a is proximate the inlet end of the reactor tube 8. The linked set 10a and the additional plurality of catalyst carriers 10b extend at least part way between the inlet end of the reactor tube 8 and the outlet end of the reactor tube 8. Importantly, the additional plurality of catalyst carriers 10b are unconnected to the linked set 10a.

The linked set 10a may for example comprise from 2 to 20, and preferably from 5 to 15, catalyst carriers 10 optionally together with a spacer unit 200. A linked set of that size may be sufficiently long to include all catalyst carriers 10 that are likely to be significantly affected by a poisoning event, while still being of a size that is practical to withdraw efficiently with a significant time saving compared to replacement of all the catalyst carriers 10 in the tube.

The tubular reactor 1 is then operated to pass one or more reactants through the reactor tubes 8 from the inlet end to the outlet end of each. In a tubular reactor 1 with downflow utilising catalyst carriers 10 illustrated in FIGS. 3 to 5 and 9 to 11, reactant(s) flow downwardly through each reactor tube 8 and thus first contact the top surface 102 of the uppermost catalyst carrier 10 of the linked set 10a. The seal 104 blocks the passage of the reactant(s) around the side of the catalyst carrier 10. Therefore, the top surface 102 directs the reactants inwardly through the lateral apertures 133 into the central inlet 134 at the upper end of the inner channel 112 within the inner container wall 111 defined by the perforated inner tube 120.

The reactant(s) then enters the annular container 110 through the perforated inner tube 120 and then passes radially through the catalyst bed towards the outer container wall 113 defined by the perforated intermediate tube 121. During this passage the reactant(s) contact the catalyst and reaction occurs to form product(s).

Unreacted reactant(s) and product(s) then flow out of the annular container 110 through the perforated intermediate tube 121. The carrier outer wall 103 defined by the outer tube 122 then directs reactant(s) and product(s) upwardly between the inner surface of the carrier outer wall 103 and the perforated intermediate tube 121 until they reach the apertures 105 in the carrier outer wall 103. They are then directed through the apertures 105 and flow downwardly between the outer surface of the carrier outer wall 103 and the inner surface of the reactor tube 8 where heat transfer takes place.

The unreacted reactant(s) and product(s) may then contact the top surface 102 of the underlying catalyst carrier 10 in the stacked formation and the process described above may repeat. This pattern may repeat as the reactant(s) and product(s) pass down the stacked formation until they are collected out of the lower end of the reactor tube 8.

Some of the products, especially liquid products, may drain out of the inner channel 112 through the drain hole provided in the channel end surface 116 into the inner channel 112 of the underlying catalyst carrier 10. Such products may then continue to drain down the stacked formation of the catalyst carriers 10 and be collected out of the lower end of the reactor tubes 8.

During or after operation, and for example if it is determined that a poisoning event has occurred, the method comprises withdrawing the linked set 10a from the inlet end of the reactor tube 8 while retaining the additional plurality of catalyst carriers 10b within the reactor tube 8. The linked set 10a may, for example, be withdrawn by fastening the hydraulic ram of the installation tool 20 to the attachment point 201 and pulling the linked set 10a upwards and out of the reactor tube 8 so that all of the units of the linked set 10a (e.g. catalyst carriers 10 and spacer unit 200) are withdrawn in one go.

Optionally the tool, for example the installation tool 20, may be configured to withdraw linked sets 10a from two or more reactor tubes 8 simultaneously.

Further the method may then continue with installing into the reactor tube 8 a fresh linked set 10a of two or more catalyst carriers 10 to replace the withdrawn linked set 10a.

Withdrawal and replacement of the linked set 10a may be carried out on each of the reactor tubes 8 of the tubular reactor 1, for example where the reactor tubes 8 share a common head space 3.

1. A method of operating a tubular reactor, the tubular reactor comprising a plurality of reactor tubes configured to receive catalyst carriers configured to hold catalyst, the method comprising, for at least some of the reactor tubes, the steps of:
a) connecting together two or more catalyst carriers to form a linked set;
b) installing into the reactor tube the linked set and an additional plurality of catalyst carriers that are unconnected to the linked set so that the linked set and the additional plurality of catalyst carriers extend at least part way between an inlet end of the reactor tube and an outlet end of the reactor tube, with the linked set being proximate the inlet end;
c) operating the tubular reactor to pass one or more reactants through the reactor tube from the inlet end to the outlet end; and
d) subsequently, withdrawing the linked set from the inlet end of the reactor tube while retaining the additional plurality of catalyst carriers within the reactor tube.

2. The method of claim 1, wherein the linked set is withdrawn in one go while retaining the two or more catalyst carriers of the linked set connected to one other.

3. The method of claim 1, further comprising the step of: c1) determining that a poisoning event has occurred that has affected catalyst held in the linked set and, based on that determination, proceeding with step d).

4. The method of claim 1, further comprising the step of: e) installing into the reactor tube a fresh linked set of two or more catalyst carriers to replace the withdrawn linked set.

5. The method of claim 1, wherein the linked set is installed into and withdrawn from the inlet end of the reactor tube.

6. The method of claim 1, wherein the two or more catalyst carriers of the linked set are connected together by a bayonet fitting, an interference fit or a screw-threaded fitting.

7. The method of claim 1, wherein the linked set additionally comprises a spacer unit connected to the two or more catalyst carriers, the spacer unit being provided at one end of the linked set.

8. The method of claim 7, wherein on installing the linked set into the reactor tube the spacer unit is aligned with a first or top sheet of the tubular reactor.

9. The method of claim 1, further comprising providing an inlet end of the linked set with an attachment point, and wherein withdrawing the linked set from the inlet end of the reactor tube comprises attaching a tool to the attachment point and pulling the linked set out of the inlet end using the tool.

10. The method of claim 9, wherein the tool is driven manually, hydraulically, pneumatically, or electro-mechanically.

11. The method of claim 1, wherein at least one of the catalyst carriers of the linked set is provided with a seal that engages against an inner surface of the reactor tube such that liquids and gases passing along the reactor tube are preferentially directed to flow through an interior of the catalyst carrier.

12. The method of claim 11, wherein the seal is configured to permit the catalyst carrier to be installed into the reactor tube in a first direction and withdrawn from the reactor tube in a second direction opposite to the first direction.

13. The method of claim 11, a wherein the seal is deformed on installing the catalyst carrier into the reactor tube.

14. The method claim 11, wherein the seal comprises one or more layers that extend outwardly from a container of the catalyst carrier.

15. The method of claim 14, wherein the seal comprises at least a first seal layer and a second seal layer;
the first seal layer and the second seal layer each comprising a plurality of deflectable tongues separated by notches;
the second seal layer being rotationally offset about the longitudinal axis of the catalyst carrier relative to the first seal layer such that the notches of the second seal layer are aligned with the deflectable tongues of the first seal layer.

16. The method of claim 14, wherein the seal is deformed on installation such that the one or more layers are flexed to point back towards the inlet end of the reactor tube during installation.

17. The method of claim 14, wherein the seal is deformed on withdrawal such that the one or more layers are flexed to point back towards the outlet end of the reactor tube during withdrawal.

18. The method of claim 11, wherein the seal comprises an O-ring, ceramic fibre ring, or metal brush seal.

19. A linked set of two or more catalyst carriers, wherein the two or more catalyst carriers are connected together end-to-end, the linked set comprising an attachment point for withdrawing the linked set in one go from an inlet end of a reactor tube.

20. The linked set of claim 19, wherein the linked set additionally comprises a spacer unit connected to the two or more catalyst carriers, the spacer unit being provided at one end of the linked set and comprising the attachment point.

21. The linked set of claim 19, wherein at least one of the catalyst carriers of the linked set is provided with a seal for engaging an inner surface of a reactor tube.

22. The linked set of claim 21, wherein the seal comprises at least a first seal layer and a second seal layer;
the first seal layer and the second seal layer each comprising a plurality of deflectable tongues separated by notches;
the second seal layer being rotationally offset about the longitudinal axis of the catalyst carrier relative to the first seal layer such that the notches of the second seal layer are aligned with the deflectable tongues of the first seal layer.

23. The linked set of claim 21, wherein the seal comprises an O-ring, ceramic fibre ring, or metal brush seal.
